(19) United States
(12) Patent Application Publication
(10) Pub. No.: US 2002/0047839 A1
(43) Pub. Date: Apr. 25, 2002

(54) Driving circuit for active matrix type display, drive method of electronic equipment and electronic apparatus, and electronic apparatus

(75) Inventor: Toshiyuki Kasai, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 09/956,030

(22) Filed: Sep. 20, 2001

(30) Foreign Application Priority Data
Sep. 20, 2000 (JP) 2000-285329(P)
Aug. 24, 2001 (JP) 2001-254850(P)

(51) Int. Cl. G09G 5/00

(52) U.S. Cl. 345/211

(57) ABSTRACT

To realize an organic electroluminescence element driving circuit capable of realizing application of reverse bias without almost increasing power consumption and cost.

The connected relationship between a power supply potential V_{cc} and the GRD is changed by manipulating switches 21 and 22. With this arrangement, application of reverse bias to an organic electroluminescence element 10 is realized without newly preparing additional power supplies such as a negative power supply, and the like, whereby the life of an organic electroluminescence element 10 can be increased.

### DETAILED DESCRIPTION OF THE INVENTION

1. Technical Field of the Invention

The present invention relates to a driving circuit for an active matrix type display using an electro-optical element such as an organic electroluminescence element (hereinafter referred to as “organic electroluminescence element”), and the like, to a driving method of electronic device and an electronic apparatus, and to the electronic device. More particularly, the present invention relates to a driving circuit having a function for applying reverse bias to an electro-optical element to suppress the deterioration thereof, to a driving method of electronic device and an electronic apparatus, and to the electronic device.

2. Description of the Related Art

It has been known that a display can be realized by arranging a plurality of pixels in matrix that comprise an organic electroluminescence element which is one of electro-optical elements. The organic electroluminescence element is arranged such that a laminated organic thin film including a light emitting layer is interposed between a cathode formed of a metal electrode, for example, Mg, Ag, Al, Li, and the like and an anode formed of a transparent electrode composed of ITO (indium tin oxide).

FIG. 8 shows an ordinary arrangement of a driving circuit for an active matrix type display using an organic electroluminescence element. In this figure, the organic electroluminescence element is shown as a diode 10. Further, the driving circuit 1 is composed of two transistors Tr1 and Tr2 each composed of a thin film transistor (TFT) and a capacitance element 2 for accumulating electric charge.

Herein both the transistors Tr1 and Tr2 are p-channel type TFTs. The transistor Tr1 is controlled to be turned on and off according to the electric charge accumulated in the capacitance element 2 in the figure. The capacitance element 2 is charged by a data line V_{DATA} through the transistor Tr2 that is turned on by setting a selection potential V_{SEL} to a low level. When the transistor Tr1 is turned on, a current flows to the organic electroluminescence element 10 through the transistor Tr1. The continuous flow of the current to the organic electroluminescence element 10 permits the same to emit light continuously.

FIG. 9 shows a brief timing chart as to the circuit of FIG. 8. As shown in FIG. 9, when data is to be written, the transistor Tr2 is turned on by setting the selection potential V_{SEL} to the low level, whereby the capacitance element 2 is charged. This charge period is a writing period T_{w} in the figure. An actual display period follows the writing period T_{w}. In this period, the transistor Tr1 is turned on by the electric charge accumulated in the capacitance element 2. This period is shown as a display period T_{H} in the figure.

FIG. 10 shows another arrangement of the driving circuit for the organic electroluminescence element. The driving circuit shown in the figure is written in the literature “The Impact of Transient Response of Organic Light organic Light Emitting Diodes on the Design of Active Matrix OLED Displays” (1998 IEEE IEDM 98-875) . In FIG. 10, reference numeral Tr1 denotes a driving transistor, reference numeral Tr2 denotes a charge controlling transistor, reference numeral Tr3 denotes a first selection transistor, and reference numeral Tr4 denotes a second selection transistor that is turned off during the charge period of a capacitance element 2.

As known well here, the characteristics of transistors are dispersed even if they have the same standard. Accordingly, even if the same voltage is applied to the gates of transistors, a current having a given value does not always flow through the transistors, which may cause irregular luminance and the like. In contrast, in this driving circuit, electric charge is accumulated in the capacitance element 2 based on an amount of current according to a data signal output from a current source 4. Thus, the emitting state of organic electroluminescence can be controlled based on the amount of current according to data.

Herein all the transistors Tr1 to Tr4 are p-channel type MOS transistors. The transistors Tr2 and TR3 are turned on by setting a selection potential V_{SEL} to a low level, which causes electric charge having a value according to the output from the current source 4 to be accumulated in the capacitance element 2. Then, after the selection potential V_{SEL} goes to a high level and the transistors Tr2 and Tr3 are turned off, the transistor Tr1 is turned on by the electric charge accumulated in the capacitance element 2 and the transistor Tr4 is turned on by a data holding control signal V_{gp} so that a current flows to the organic electroluminescence element 10.

FIGS. 11 shows a brief timing chart as to the circuit of FIG. 10. As shown in FIG. 11, when data is to be written by the current source 4, the transistors Tr2 and Tr3 are turned on by setting the selection potential V_{SEL} to the a low level, thereby charging the capacitance element 2. This charging period is a writing period T_{w} in FIG. 11. An actual display period follows the write period T_{w}. During the period in which the data holding control signal V_{gp} is set to the low level, the transistor Tr1 is turned on, and this turned-on period is a display period T_{H}.

FIG. 12 shows still another arrangement of the driving circuit for the organic electroluminescence element. The driving circuit shown in the figure is the circuit disclosed in Japanese Unexamined Patent Application Publication No. 11-272233. In this figure, the driving circuit includes a transistor Tr1 for supplying a current from a power supply to an organic electroluminescence element 10 when it is turned on, a capacitance element 2 for accumulating electric charge for maintaining the transistor Tr1 in the turned-on state, and a charge controlling transistor Tr5 for controlling the charge of the capacitance element 2 according to an external signal. Note that when the organic electroluminescence element 10 is to emit, a potential V_{rscan} is maintained to a low level to turn off a charge controlling transistor Tr7. With this operation, no reset signal V_{rsig} is output. Note that reference numeral Tr6 denotes an adjustment transistor.

The transistor Tr5 is turned on, and the capacitance element 2 is charged by a data line V_{DATA} through a transistor Tr6. Then, the conductance between the source and the drain of the transistor Tr1 is controlled according the charged level of the capacitance element 2, and a current flows to the organic electroluminescence element 10. That is, as shown in FIG. 13, when a potential V_{scan} is set to a high level to turn on the transistor Tr5, the capacitance element 2 is charged through the transistor Tr6. The conductance between the source and the drain of the transistor Tr1 is controlled according the charged level of the capacitance element 2, and a current flows to the organic electroluminescence element 10. The organic electroluminescence element 10 emitts.

Problems to be Solved by the Invention

Incidentally, it is known that application of reverse bias to an organic electroluminescence element is an effective means to increase the life thereof. This increase of life is disclosed in, for example, Japanese Unexamined Patent Application Publication No. 11-8064.

However, in the method of the publication, additional power supplies such as a negative power source, and the like must be newly prepared to apply reverse bias to the organic electroluminescence element, and the organic electroluminescence element must be controlled so as to permit the reverse bias to be applied thereto.

Accordingly, an object of the present invention is to provide a driving circuit for an active matrix type display capable of applying reverse bias to an electro-optical element such as an organic electroluminescence element, and the like without almost increasing power consumption and cost, to provide a driving method of electronic device and an electronic apparatus, and to provide electronic device.

Means for Solving the Problems

A first driving circuit for active matrix type display according to the present invention is a driving circuit for driving a display in which a plurality of pixels composed of an electro-optical element are disposed in matrix, the driving circuit including:

a first terminal electrically connected to any one of a first power supply line for supplying a first potential and a second power supply line for supplying a second potential lower than the first potential; and

a second terminal electrically connected to any one of the first and second power supply lines through the electro-optical element,

wherein timing at least exists at which, when the electro-optical element is in a first operating state, the first terminal is electrically connected to the first power supply line and the second terminal is electrically connected to the second power-supply line through the electro-optical element; and

at which, when the electro-optical element is in a second operating state, the first terminal is electrically connected to the second power supply line and the second terminal is electrically connected to the first power supply line through the electro-optical element.

A second driving circuit for active matrix type display according to the present invention further includes:

a driving transistor for controlling an operating state of the electro-optical element;

a capacitance element for accumulating electric charge for maintaining the driving transistor in a turned-on state; and

a charge controlling transistor for controlling the charge to the capacitance element according to an external signal,

wherein one of the electrodes constituting the capacitance element is electrically connected to the first terminal and the other electrode constituting the capacitance element is electrically connected to the gate electrode of the driving transistor; and

the first terminal is electrically connected to the second terminal through the source and the drain of the driving transistor.

A third driving circuit for active matrix type display according to the present invention further includes:

a driving transistor for controlling an operating state of the electro-optical element;

a capacitance element for accumulating electric charge for maintaining the driving transistor in a turned-on state; and

a charge controlling transistor for controlling the charge to the capacitance element according to an external signal,

wherein one of the electrodes constituting the capacitance element is electrically connected to the first terminal through a selection transistor that is turned off during the charge period of the capacitance element;

the other electrode constituting the capacitance element is electrically connected to the gate electrode of the driving transistor; and

the first terminal is electrically connected to the second terminal through the source and the drain of the driving transistor and through the source and the drain of the selection transistor.

A fourth driving circuit for active matrix type display according to the present invention further includes;

a driving transistor for controlling an operating state of the electro-optical element;

a capacitance element for accumulating electric charge for maintaining the driving transistor in a turned-on state; and

a charge controlling transistor for controlling the charge to the capacitance element according to an external signal,

wherein one of the electrodes constituting the capacitance element is electrically connected to the gate electrode of the driving transistor;

the other electrode constituting the capacitance element is electrically connected to the ground; and

the first terminal is electrically connected to the second terminal through the source and the drain of the driving transistor.

In short, since a connected state of the first power supply and the second power supply to the driving circuit is changed by switches, reverse bias can be applied to an organic electroluminescence element without almost increasing power consumption and cost. In this case, a first power supply is ordinarily set to Vcc and a second power supply is ordinarily set to the ground (GND), and potentials which are originally prepared are used. However, when a difference of potential that is sufficient for the organic electroluminescence element to emit can be secured, the power supplies are not limited thereto.

In a fifth driving circuit for active matrix type display of the present invention, the electro-optical element is an organic electroluminescence element.

A first electronic apparatus of the present invention is an electric apparatus having an active matrix type display that includes the driving circuit.

A first method of driving electronic device of the present invention is a method of driving electronic device including a first power supply line having a first potential, a second power supply line having a second potential that is a potential lower than the first potential, and an electronic device electrically disposed between the first power supply line and the second power supply line, the method including the steps of:

electrically connecting one end of the electronic element to the second power supply line when the other end of the electronic element is electrically connected to the first power supply line; and

electrically connecting one end of the electronic element to the first power supply line when the other end of the electronic element is electrically connected to the second power supply line.

It should be noted that the terms “electrically disposed” are not always limited to the case that an electron element is directly connected to a power supply line and also includes the case that other element such as a transistor or the like is disposed between the power supply line and the electronic element. A liquid crystal element, an electrophoretic element, an electroluminescence element, and the like, for example, are exemplified as the electronic element. Further, the electronic element means a element that is driven when a voltage is applied or a current is supplied thereto.

In a second method of driving electronic equipment of the present invention, the electronic device is a current-driven device that is driven by a current.

That is, when the electronic device is the current-driven element, a current flows in a forward direction or a reverse direction by the driving method.

A first electronic device of the present invention is electronic device including a first power supply line having a first potential, a second power supply line having a second potential that is a potential lower than the first potential, and an electronic element electrically disposed between the first power supply line and the second power supply line, wherein;

one end of the electronic element is electrically connected to the second power supply line when the other end of the electronic element is electrically connected to the first power supply line; and

one end of the electronic element is electrically connected to the first power supply line when the other end of the electronic element is electrically connected to the second power supply line.

In second electronic device of the present invention, the electronic element is disposed in a unit circuit that is disposed in correspondence to the node of a data line for supplying a data signal and a scan line for supplying a scan signal in the above electronic device.

In third electronic device of the present invention, the unit circuit includes:

a first transistor for controlling the conductivity of the electronic element;

a second transistor the gate electrode of which is connected to the scan line; and

a capacitance element connected to the gate electrode of the first transistor for accumulating electric charge corresponding to the data signal supplied from the data line.

Embodiment

Next, an embodiment of the present invention will be described with reference to the drawings. Note that, in the respective drawings referred to in the following description, the same components as those in other drawings are denoted by the same reference numerals.

FIG. 1 is a block diagram showing a driving circuit for an active matrix type display using an organic electroluminescence element according to the present, invention. As shown in the figure, the driving circuit 1 for the organic electroluminescence element of the embodiment has a first terminal A. The first terminal A can be electrically connected to any one of a first power supply line for supplying a first potential (V_{cc}) and a second power supply line for supplying a second potential GND lower than the first potential by a switch 21.

Further, the driving circuit 1 for the organic electroluminescence element includes a second terminal B. The second terminal B is electrically connected to a switch 22 through an organic electroluminescence element 10. The second terminal B can be electrically connected to any one of the first power supply line for supplying the first potential (V_{cc}) and the second power supply line for supplying the second potential GND lower than the first potential by a switch 22 through the organic electroluminescence element 10. Note that the first potential (V_{cc}) is a potential higher than the second potential (GND) and, for example, about 10 V.

When the organic electroluminescence element 10 emits (first operating state), that is, when display is performed, it is sufficient that the switch 21 be set to the first power supply line for supplying the first potential (V_{cc}) and that the switch 22 be set to the second power supply line for supplying the second potential (GND). At this time, the first terminal A is electrically connected to the first power supply line, and the second terminal B is electrically connected to the second power supply line through the organic electroluminescence element 10.

In contrast, when the organic electroluminescence device 10 does not emit (second operating state), that is, when no display is performed, it is sufficient that the switch 21 be set to the second power supply line for supplying the second potential (GND) and that the switch 22 be set to the first power supply line for supplying the first potential (V_{cc}). At this time, the first terminal A is electrically connected to the second power supply line, and the second terminal B is electrically connected to the first power supply line through the organic electroluminescence element 10. Since the potential of the second terminal B does not exceed the first potential (V_{cc}) in the above electrically-connected relationship, reverse bias is applied to the organic electroluminescence element 10. However, it is not necessary to continue the above electrically-connected relationship over the entire period during which the organic electroluminescence element 10 is in the second operating state. That is, it is sufficient to maintain the electrically-connected relationship in at least a part of the above period during which the organic electroluminescence element 10 is in the second operating state.

As described above, reverse bias can be applied to the organic electroluminescence element 10 only by changing the setting of the first and second switches 21 and 22. Since a power supply and GND which are prepared from the beginning are utilized in this case, it is not necessary to newly prepare additional power supplies such as a negative power supply and the like. Thus, power consumption is not increased as well as an increase in cost does not occur. Note that each of these switches 21 and 22 can be easily realized by the combination of transistors.

### EXAMPLES

FIG. 2 is a block diagram showing the internal arrangement of a driving circuit according to a first example. In this figure, the circuit arrangement of FIG. 8 described above is employed in a driving circuit 1. That is, the driving circuit 1 includes a driving transistor Tr1 for controlling the operating state of an organic electroluminescence element 10, a capacitance element 2 for accumulating electric charge for maintaining the transistor Tr1 in a turned-on state, and a charging controlling transistor Tr2 for controlling the charge to the capacitance element 2 according to an external signal. In the driving circuit 1, one of the electrodes constituting the capacitance element 2 is electrically connected to a first terminal A, and the other electrode thereof constituting the capacitance element 2 is electrically connected to the gate electrode of the driving transistor Tr1. Further, one of the source and the drain constituting the driving transistor Tr1 is electrically connected to the first terminal A, and the other thereof constituting the driving transistor Tr1 is electrically connected to the second terminal B. As a result, the first terminal A is electrically connected to the second terminal B through the source and the drain of the driving transistor Tr1.

Then, an electrically-connected-state of the first terminal A and the second terminal B is changed by the switches 21 and 22. That is, when the organic electroluminescence element 10 emits (first operating state), the switch 21 is set to a power supply potential V_{cc}, and the switch 22 is set to the ground GND. It is sufficient in this state that the capacitance element 2 be charged, that the driving transistor Tr1 be turned on, and that a current flows to the organic electroluminescence element 10.

In contrast, when the organic electroluminescence element 10 does not emit (second operating state), it is sufficient that the switch 21 be set to the ground GND and that the switch 22 be set to the power supply potential V_{cc}. In this case, a selection potential V_{SEL} is maintained to the power supply potential V_{cc}. The potential (V_{D}) of the first terminal A is dropped from the power supply potential V_{cc} to the ground potential GND, and, after the drop thereof, the potential (Vₛ) of a third terminal C is risen from the ground potential GND to the power supply potential V_{cc}. Thus, the gate potential V₁ of the driving transistor Tr1 drops following the change of the potential V_{D}. Ordinarily, a wiring capacitance (not shown) is added to the gate line of the driving transistor Tr1. However, if the magnitude of the capacitance is negligible with respect to the capacitance of the capacitance element 2, the gate potential V₁ drops by the power supply potential V_{cc} when the potential V_{D} of the first terminal A changes from the power supply potential V_{cc} to the ground potential GND. At this time, the potential of the second terminal B is equal to the threshold voltage (Vₜₕ) of the driving transistor Tr1 at the largest, whereby reverse bias is applied to the organic electroluminescence element 10 because the potential Vₛ of the third terminal C is set to the power supply potential V_{cc}.

As described above, reverse bias can be applied to the organic electroluminescence element 10 only by changing the setting of the first and second switches 21 and 22. Since it is not necessary to newly prepare additional power supplies such as a negative power supply and the like, power consumption is not increased as well as a great increase in cost does not happen.

FIG. 4 is a block diagram showing the internal arrangement of a drivin circuit according to a second example. In this figure, the circuit arrangement of FIG. 10 described above is employed in the driving circuit 1. That is, the driving circuit includes a driving transistor Tr1 for controlling the operating state of an organic electroluminescence element 10, a capacitance element 2 for accumulating electric charge for controlling the conductive state of the transistor Tr1, and a charge controlling transistor Tr2 for controlling the charge to the capacitance element 2 according to an external signal. In the driving circuit 1, one of the electrodes constituting the capacitance element 2 is electrically connected to a first terminal A through a second selection transistor Tr4, and the other electrode thereof constituting the capacitance element 2 is electrically connected to the gate electrode of the driving transistor Tr1. Further, one end of the driving transistor Tr1 is electrically connected to the first terminal A through the second selection transistor Tr4, and the other end thereof is electrically connected to the second terminal B. As a result, the first terminal A is electrically connected to the second terminal B through the sources and the drains of the driving transistor Tr1 and the selection transistor Tr4.

As known well here, the characteristics of transistors are dispersed even if they have the same standard. Accordingly, even if the same voltage is applied to the gates of transistors, a current having a given value does not always flow to the transistors, which may cause irregular luminance and the like. In contrast, in this driving circuit, electric charge is accumulated in the capacitance element 2 based on an amount of current according to a data signal output from a current source 4. Thus, the emitting state of organic electroluminescence can be controlled based on the amount of current according to data.

In this driving circuit, the electrically-connected relationship between the first terminal A and the second terminal B is changed to a power supply potential V_{cc} and the ground potential GND by switches 21 and 22. That is, when the organic electroluminescence element 10 is to emit, it is sufficient that the switch 21 be set to the power supply potential V_{cc}, that the switch 22 be set to the ground potential GND, that the transistor Tr1 be turned on, that the transistor Tr4 be turned on, and that a current flows to the organic electroluminescence element 10.

In contrast, when reverse bias is to be applied to the organic electroluminescence element 10, it is sufficient that the switch 21 be set to the ground potential GND and that the switch 22 is set to the power supply potential V_{cc}. In this case, as shown in FIG. 5, a selection potential V_{SEL} is maintained to the power supply potential V_{cc}, and a data maintaining control signal V_{gp} is maintained to the ground potential GND. Then, the potential V_{D} of the first terminal A is dropped from the power supply potential V_{cc} to the ground GND. After the drop of the potential V_{D}, the potential Vₛ of the third terminal C is risen from the ground potential GND to the power supply potential V_{cc}. FIG. 5 shows only the operation after a current has been written in the driving circuit.

The potential V₁ of a node D drops from the power supply potential V_{cc} to the threshold voltage Vₜₕ of the transistor Tr4 following the drop of the potential V_{D} of the first terminal A from the power supply potential V_{cc} to the ground GND because the transistor Tr4 is turned on at all times. At this time, a wiring capacitance (not shown) is ordinarily added to the gate line of the transistor Tr1. However, if the magnitude of the capacitance is negligible with respect to the capacitance of the capacitance element 2, the potential V₂ of a node E changes to V₂−(V_{cc}−Vₜₕ). Further, when the potential V₂ is V₂−(V_{cc}−Vₜₕ), the potential V₃ of the second terminal B drops to the threshold voltage Vₜₕ. Note that the above description assumes that the threshold voltage of the transistor Tr1 is equal to that of the transistor Tr4. Reverse bias is applied to the organic electroluminescence element 10 as described above.

Application of reverse bias to the organic electroluminescence element 10 can be realized only by changing the setting of the switches as described above. Since it is not necessary to newly prepare additional power supplies such as a negative power supply, and the like, power consumption is not increased as well as a great increase in cost does not occur.

FIG. 6 is a block diagram showing the internal arrangement of a driving circuit according to a third example. In this figure, the circuit disclosed in Japanese Unexamined Patent Application Publication No. 11-272233 is employed in the driving circuit 1. That is, the driving circuit 1 includes a driving transistor Tr1 for controlling the operating state of an organic electroluminescence element 10, a capacitance element 2 for accumulating electric charge for maintaining the transistor Tr1 in a turned-on state, and a charge controlling transistor Tr5 for controlling the accumulated state of electric charge of the capacitance element 2 according to an external signal. In the driving circuit 1, one of the electrodes constituting the capacitance element 2 is electrically connected to the gate electrode of the transistor Tr1, and the other electrode thereof constituting the capacitance element 2 is electrically connected to the ground GND. Further, one of the source and the drain constituting the driving transistor Tr1 is electrically connected to a first terminal A, and the other thereof constituting the driving transistor Tr1 is electrically connected to a second terminal B. As a result, the first terminal A is electrically connected to the second terminal B through the source and the drain of the driving transistor Tr1. Note that, in the figure, the transistor Tr1 and a transistor Tr6 are P-channel type transistors, and the transistor Tr5 and a transistor Tr7 are N-channel type transistors. Further, the transistor Tr6 connected to a diode has an effect for compensating the dispersion of the threshold value of the transistor Tr1.

In this driving circuit, the electrically-connected relationship between the first terminal A and the second terminal B is changed to a power supply potential V_{cc} and to the ground potential GND by switches 21 and 22. That is, when an organic electroluminescence element 10 is to be emitted, the switch 21 is set to the power supply potential V_{cc}, and the switch 22 is set to the ground potential GND. In this state, the transistor Tr5 is turned on and the capacitance element 2 is charged through the transistor Tr6. Then, it is sufficient that the conductance between the source and the drain of the transistor Tr1 be controlled according the charged level and that a current flows to the organic electroluminescence element 10.

In contrast, when reverse bias is to be applied to the organic electroluminescence element 10, it is sufficient that the switch 21 be set to the ground potential GND and that the switch 22 be set to the power supply potential V_{cc}. In this case, first, the potential V_{SCAN} that is to be applied to the gate electrode of the transistor Tr5 is set to the power supply potential V_{cc}, and then the capacitance element 2 is charged, as shown in FIG. 7. At this time, the potential V_{SCAN} is set to the power supply potential V_{cc} for a period during which the capacitance element 2 maintains (charges) electric charge which is sufficient to turn on the transistor Tr1. A data line V_{DATA} must be set to a potential that permits the transistor Tr1 to be turned on. After the capacitance element 2 has been charged, the switch 21 is manipulated to drop the potential V_{D} of the first terminal A from the power supply potential V_{cc} to the ground potential GND. Thereafter, the switch 22 is manipulated to rise the potential V_{S} of a third terminal C from the ground potential GND to the power supply potential V_{cc}. Note that the transistor Tr7 is a reset transistor. When reverse bias is to be applied to the organic electroluminescence element 10, a potential V_{RSCAN} is maintained to the ground potential GND to turn off the transistor Tr7.

As described above, reverse bias can be applied to the organic electroluminescence element 10 only by changing the setting of the switches. Since it is not necessary to newly prepare additional power supplies such as a negative power supply, and the like, power consumption is not increased as well as a great increase in cost does not happen.

Note that while these two switches 21 and 22 are manipulated at shift timing in the above respective examples, it is apparent that they may be manipulated at the same time. When a change control signal is input to each of these switches at the shift timing, they can be manipulated at different timing. In this case, it is sufficient to input the respective control signals of the two switches through buffers each having a different number of stages.

While the driving circuits for the active matrix type display using the organic electroluminescence element have been described above, the scope of application of the present invention is not limited thereto, and the present invention also can be applied to an active matrix type display using electro-optical elements other than the organic electroluminescence element, for example, a TFT-LCD, a FED (field emission display), an electrophoresis element, a field inversion device, a laser diode, a LED, and the like.

Next, some examples of electronic apparatus to which the active matrix type display including a driving circuit 1 described above. FIG. 14 is a perspective view showing the arrangement of a mobile type personal computer to which this active matrix type display is applied. In this figure, the personal computer 1100 is composed of a main body 1104 having a key board 1102 and a display unit 1106 which includes the active matrix type display 100.

Further, FIG. 15 is a perspective view showing the arrangement of a mobile phone having a display to which the active matrix type display 100 including the aforementioned driving circuit is applied.

In this figure, the mobile phone 1200 includes the aforementioned active matrix type display 100 together with a voice receiving port 1204 and a voice transmission port 1206, in addition to a plurality of manipulation buttons 1202.

Further, FIG. 16 is a perspective view showing the arrangement of a digital still camera having a finder to which the active matrix type display 100 including the aforementioned driving circuit is applied. Note that this figure also simply shows connection to an external unit. The digital still camera 1300 creates an imaging signal by photoelectrically converting the light image of a subject by an imaging device such as a CCD (charge coupled device) or the like, while an ordinary camera exposes a film using the light image of the subject. The active matrix type display 100 is disposed on the back surface of the case 1302 of the digital still camera 1300 so as to make display based on the imaging signal created by the CCD, and the active matrix type display 100 acts as a finder for displaying the subject. Further, a light receiving unit 1304 including an optical lens, the CCD, and the like is disposed on the observing side (back surface side in the figure) of the case 1302.

When a photographer confirms the image of the subject displayed in the driving circuit and depresses a shutter button 1306, the imaging signal of the CCD at that time is transferred to and stored in the memory of a circuit substrate 1308. Further, in this digital still camera 1300, video signal output terminals 1312 and a data communication input/output terminal 1314 are disposed on a side of the case 1302. Then, as shown in the figure, a TV monitor 1430 is connected to the former video signal output terminals 1312 and a personal computer 1440 is connected to the latter data communication input/output terminal 1314, respectively when necessary. Further, the imaging signal stored in the memory of a circuit substrate 1308 is output to the TV monitor 1430 and the personal computer 1440.

Note that exemplified as the electronic apparatus to which the active matrix type display 100 of the present invention is applied are a liquid crystal TV, view finder type and monitor-directly-observing type video tape recorders, a car navigator, a pager, an electronic note book, a pocket calculator, a word processor, a workstation, a TV phone, a POS terminal, equipment provide with a touch panel, and the like, in addition to the personal computer of FIG. 14, the mobile phone of FIG. 15, and the digital still camera of FIG. 16. It is needless to say that the aforementioned active matrix type display 100 can be applied as the display of these various types of electronic equipment.

Advantages

As described above, the present invention has an advantage that application of reverse bias can be realized by changing a connected state of a first power supply having a first potential and that of a second power supply having a second potential by switches without the need of newly preparing additional power supplies such as a negative power supply, and the like and without almost increasing power consumption and cost.

### BRIEF DESCRIPTION OF THE DRAWINGS

FIG. 1

FIG. 1 is a block diagram showing an embodiment of a driving circuit for an organic electroluminescence element according to the present invention.

FIG. 2

FIG. 2 is a block diagram showing a first example of the driving circuit for the organic electroluminescence element according to the present invention.

FIG. 3

FIGS. 3 is a waveform view showing the operation of the driving circuit for the organic electroluminescence element of FIG. 2.

FIG. 4

FIG. 4 is a block diagram showing a second example of the driving circuit for the organic electroluminescence element according to the present invention.

FIG. 5

FIG. 5 is a waveform view showing the operation of the circuit of FIG. 4.

FIG. 6

FIG. 6 is a block diagram showing a third example of the driving circuit for the organic electroluminescence element according to the present invention.

FIG. 7

FIG. 7 is a waveform view showing the operation of the circuit of FIG. 6.

FIG. 8

FIG. 8 is a block diagram showing an example of the arrangement of a driving circuit for a conventional organic electroluminescence element.

FIG. 9

FIG. 9 is a waveform view showing the operation of the circuit of FIG. 8.

FIG. 10

FIG. 10 is a block diagram showing another example of the arrangement of the driving circuit for the conventional organic electroluminescence element.

FIG. 11

FIG. 11 is a waveform view showing the operation of the circuit of FIG. 10.

FIG. 12

FIG. 12 is a block diagram showing another example of the arrangement of the driving circuit for the conventional organic electroluminescence element.

FIG. 13

FIG. 13 is a waveform view showing the operation of the circuit of FIG. 12.

FIG. 14

FIG. 14 is a view showing an example when an active matrix type display including the driving circuit according to an example of the present invention is applied to a mobile type personal computer.

FIG. 15

FIG. 15 is a view showing an example when an active matrix type display including the driving circuit according to an example of the present invention is applied to the display of a mobile phone.

FIG. 16

FIG. 16 is a perspective view showing a digital still camera when an active matrix type display including the driving circuit according to an example of the present invention is applied to a finder portion.

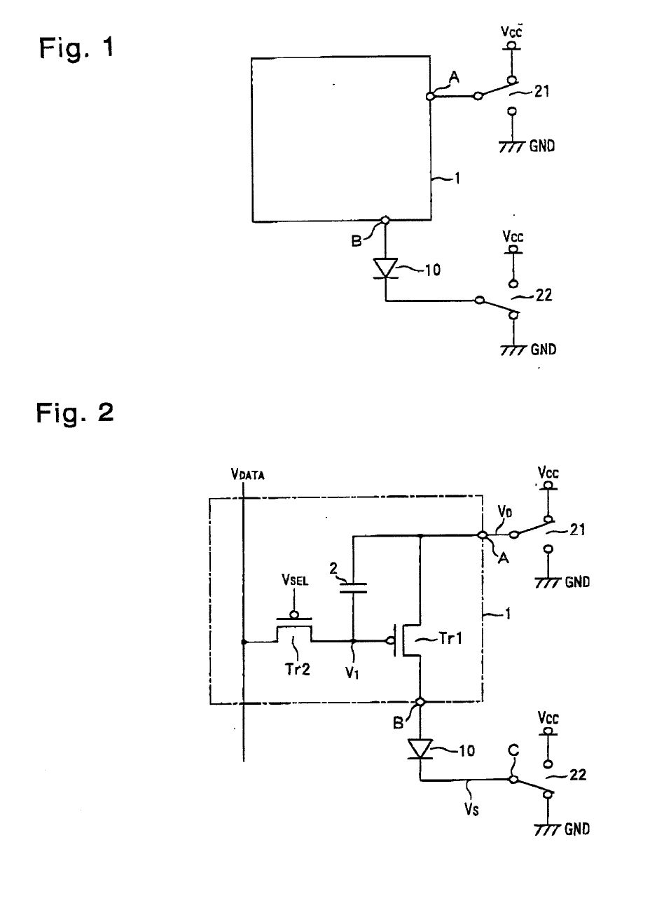

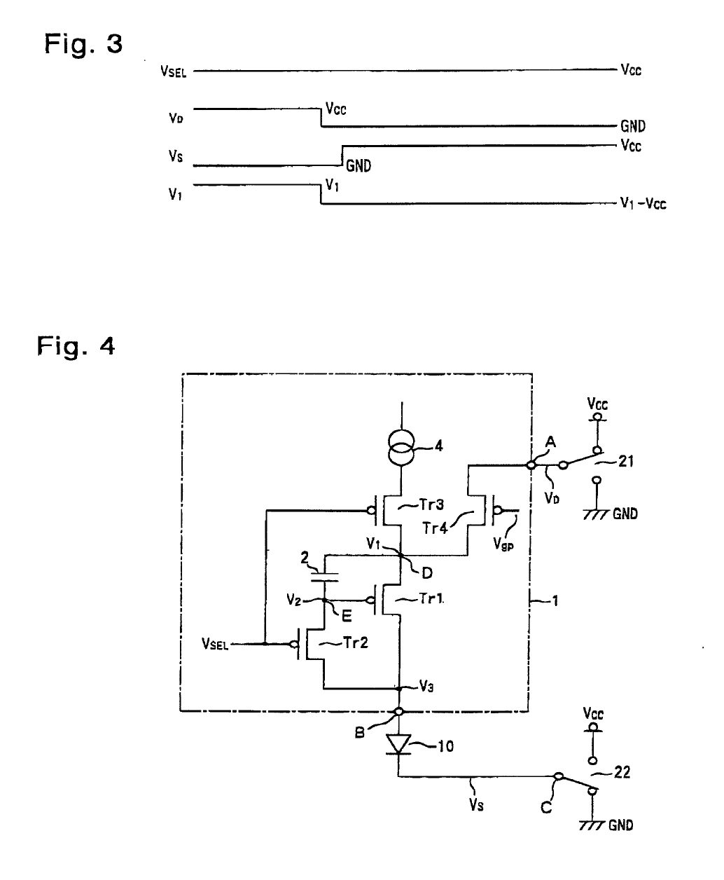

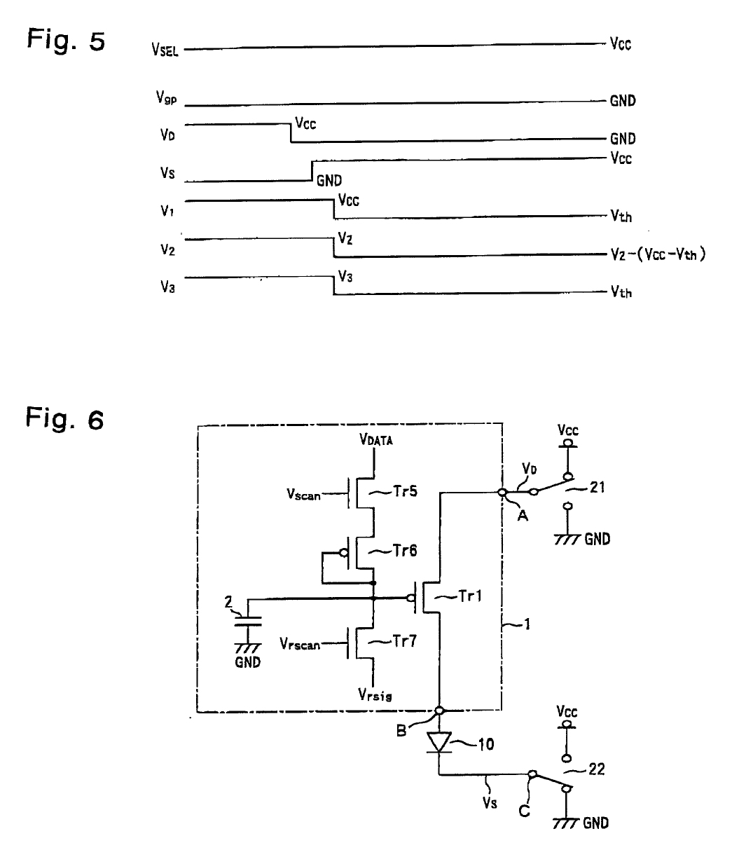

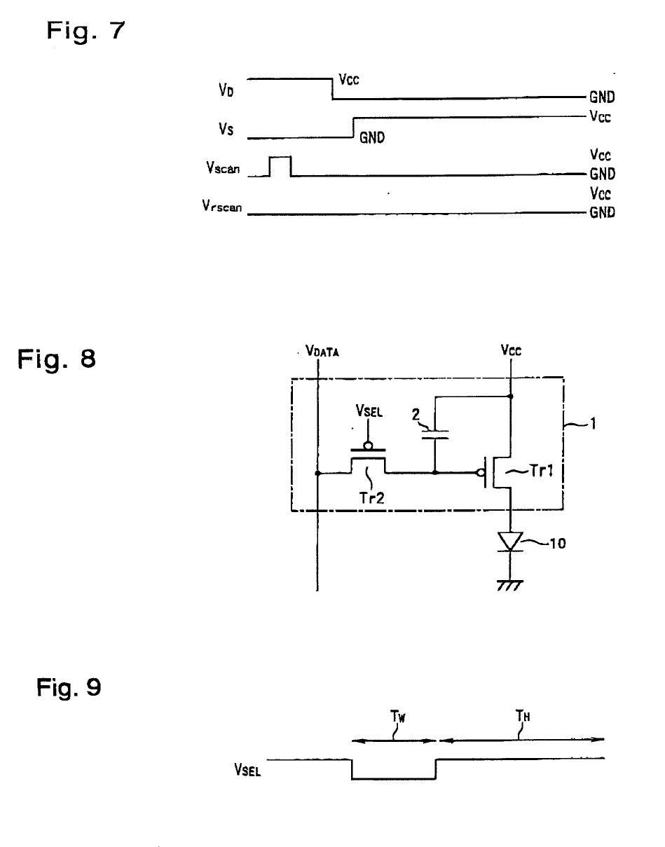

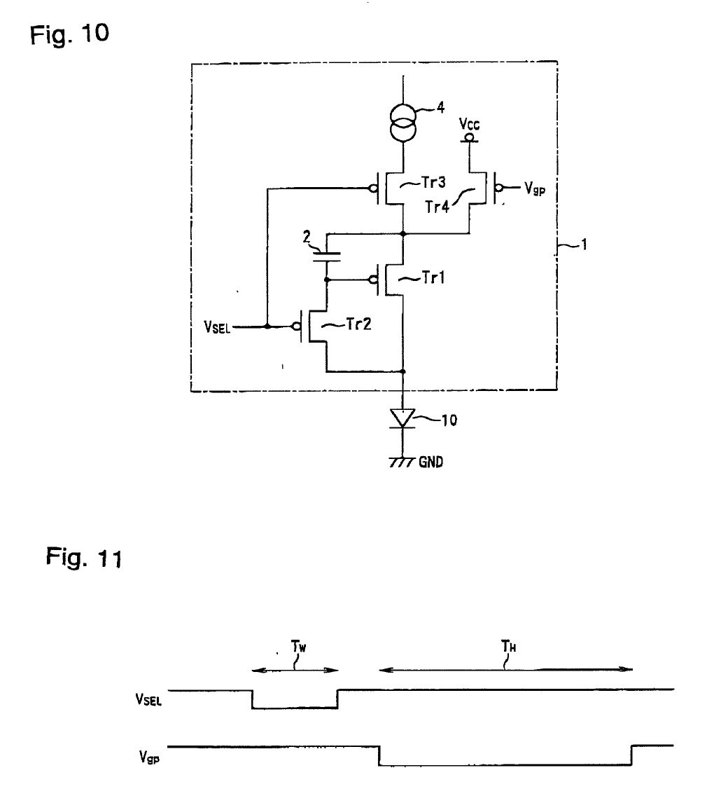

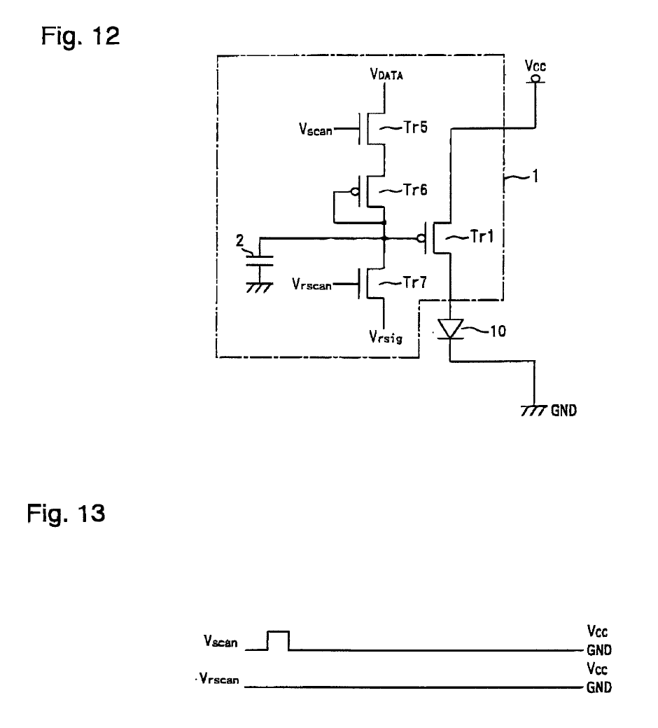

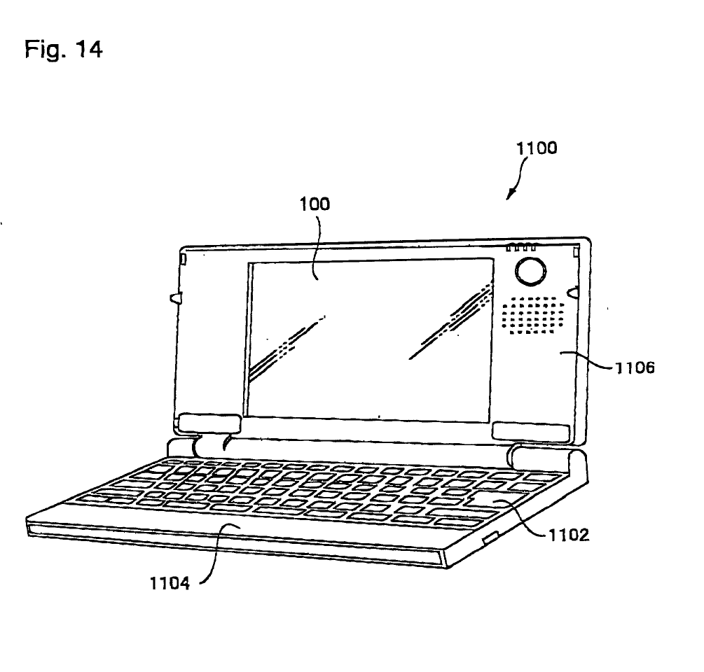

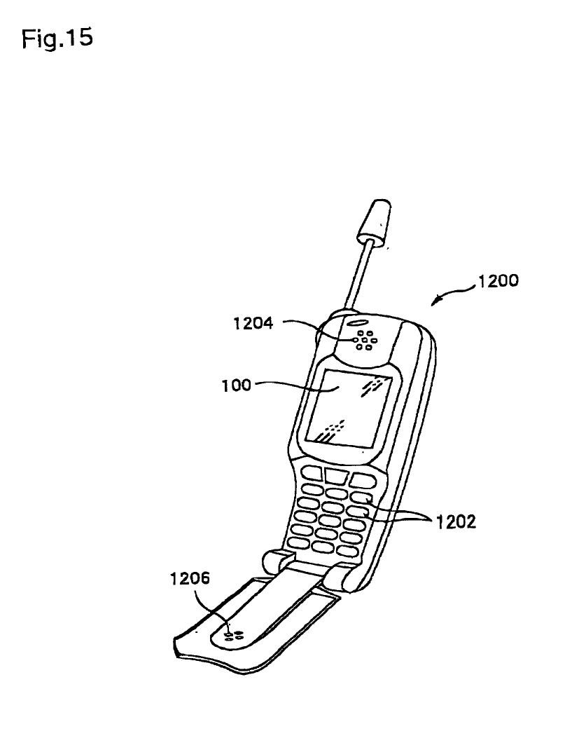

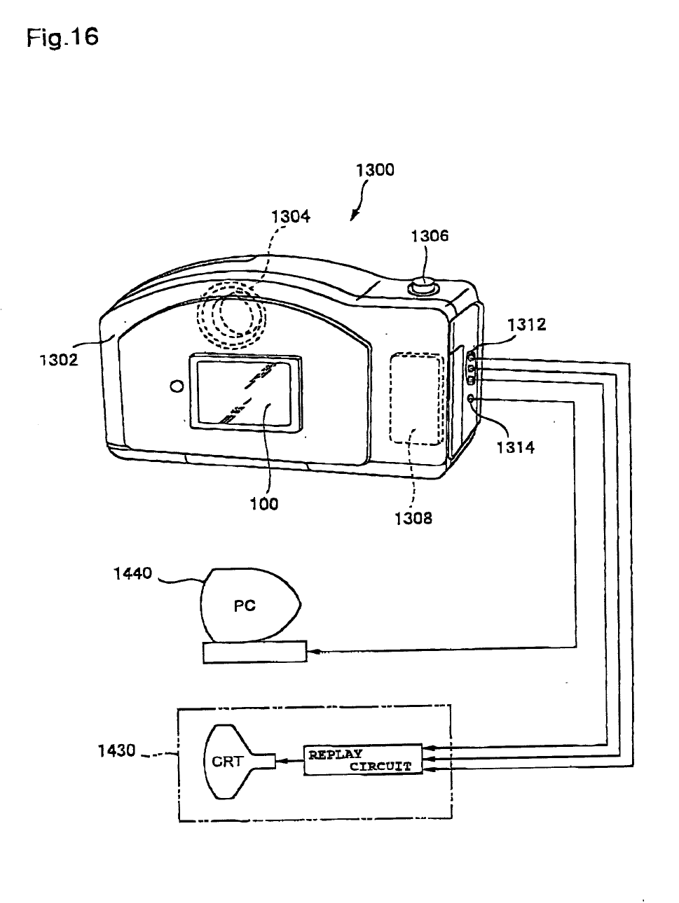

### REFERENCE NUMERALS

1: driving circuit

2: capacitance element

4: current source

10: organic electroluminescence element

21, 22: switch

Tr1-Tr7: transistor

What is claimed is:

1. A driving circuit for driving an active matrix type display in which a plurality of pixels including of an electro-optical element are disposed in matrix, comprising:
a first terminal electrically connected to any one of a first power supply line for supplying a first potential and a second power supply line for supplying a second potential lower than the first potential; and
a second terminal electrically connected to any one of the first and the second power supply lines through the electro-optical element,
the first terminal and the second terminal being electrically connected to the first power supply line and second power supply line, respectively, through the electro-optical element when the electro-optical element is in a first operating state; and
the first terminal and the second terminal being electrically connected to the second power supply line and the first power supply line, respectively, through the electro-optical element when the electro-optical element is in a second operating state.

2. The driving circuit for an active matrix type display according to claim 1, further comprising:
a driving transistor for controlling an operating state of the electro-optical element;
a capacitance element for accumulating electric charge for maintaining the driving transistor in a turned-on state; and
a charge controlling transistor for controlling the electric charge to the capacitance element according to an external signal,
one of the electrodes constituting the capacitance element being electrically connected to the first terminal; and the other electrode constituting the capacitance element being electrically connected to the gate electrode of the driving transistor; and
the first terminal being electrically connected to the second terminal through the source and the drain of the driving transistor.

3. The driving circuit for an active matrix type display according to claim 1, further comprising:
a driving transistor for controlling an operating state of the electro-optical element;
a capacitance element for accumulating electric charge for maintaining the driving transistor in a turned-on state; and
a charge controlling transistor for controlling the electric charge to the capacitance element according to an external signal,
one of the electrodes constituting the capacitance element being electrically connected to the first terminal through a selection transistor that is turned off during the charge period of the capacitance element;
the other electrode constituting the capacitance element being electrically connected to the gate electrode of the driving transistor; and
the first terminal being electrically connected to the second terminal through the source and the drain of the driving transistor and through the source and the drain of the selection transistor.

4. A driving circuit for an active matrix type display according to claim 1, further comprising:
a driving transistor for controlling an operating state of the electro-optical element;
a capacitance element for accumulating electric charge for maintaining the driving transistor in a turned-on state; and
a charge controlling transistor for controlling the electric charge to the capacitance element according to an external signal,
one of the electrodes constituting the capacitance element being electrically connected to the gate electrode of the driving transistor;
the other electrode constituting the capacitance element being electrically connected to the ground; and
the first terminal being electrically connected to the second terminal through the source and the drain of the driving transistor.

5. The driving circuit for an active matrix type display according to claim 1, the electro-optical element being an organic electroluminescence element.

6. An electronic equipment having an active matrix type display that includes the driving circuit according to claim 1.

7. A method of driving electronic device including a first power supply line having a first potential, a second power supply line having a second potential that is a potential lower than the first potential, and an electronic element electrically disposed between the first power supply line and the second power supply line, comprising the steps of:
electrically connecting one end of the electronic element to the second power supply line when the other end of the electronic element is electrically connected to the first power supply line; and
electrically connecting one end of the electronic element to the first power supply line when the other end of the electronic element is electrically connected to the second power supply line.

8. A method of driving electronic device according to claim 7, the electronic element being a current-driven element that is driven by a current.

9. An electronic device including a first power supply line having a first potential, a second power supply line having a second potential that is a potential lower than the first potential, and an electronic element electrically disposed between the first power supply line and the second power supply line,
one end of the electronic element being electrically connected to the second power supply line when the other end of the electronic element is electrically connected to the first power supply line; and
one end of the electronic element being electrically connected to the first power supply line when the other end of the electronic element is electrically connected to the second power supply line.

10. The electronic apparatus according to claim 9, the electronic element being disposed in a unit circuit that is disposed in correspondence to the node of a data line for supplying a data signal and a scan line for supplying a scan signal.

11. The electronic apparatus according to claim 10, the unit circuit comprising:
a first transistor for controlling the conductivity of the electronic element;
a second transistor of which the gate electrode is connected to the scan line; and
a capacitance element connected to the gate electrode of the first transistor for accumulating electric charge corresponding to the data signal supplied from the data line.

12. The driving circuit for an active matrix type display according to claim 2, the electro-optical element being an organic electroluminescence element.

13. The driving circuit for an active matrix type display according to claim 3, the electro-optical element being an organic electroluminescence element.

14. The driving circuit for an active matrix type display according to claim 4, the electro-optical element being an organic electroluminescence element.

15. An electronic equipment having an active matrix type display that includes the driving circuit according to claim 2.

16. An electronic equipment having an active matrix type display that includes the driving circuit according to claim 3.

17. An electronic equipment having an active matrix type display that includes the driving circuit according to claim 4.

18. An electronic equipment having an active matrix type display that includes the driving circuit according to claim 5.
